(19) United States
(12) Patent Application Publication
(10) Pub. No.: US 2002/0161790 A1
(43) Pub. Date: Oct. 31, 2002

(54) Data mining techniques for enhancing department store space management

(75) Inventors: Menachem Levanoni, Yorktown Heights, NY (US); Jerome M. Kurtzberg, Yorktown Heights, NY (US)

Correspondence Address: Stephen C. Kaufman, Intellectual Property Law Dept., IBM Corporation, P.O. Box 218, Yorktown Heights, NY, 10598, US

(73) Assignee: International Business Machines Corporation

(21) Appl. No.: 09/845,648

(22) Filed: Apr. 30, 2001

(51) Int. Cl. G06F 7/00

(52) U.S. Cl. 707/205

(57) ABSTRACT

A computer method for enhancing department store space management. The method includes the steps of providing a department store space-requirements database comprising a compendium of individual department store space-requirements history; providing a department store space-availability database comprising a compendium of at least one of department store space management solutions, department store space information, and department store space diagnostics; and, employing a data mining technique for interrogating the department store space-requirements and department store space-availability databases for generating an output data stream, the output data stream correlating department store space-requirements problem with department store space-availability solution.

### BACKGROUND OF THE INVENTION

1. Field of the Invention

This invention relates to methodology for utilizing data mining techniques in the area of department store space management.

2. Introduction to the Invention

Data mining techniques are known and include disparate technologies, like neural networks, which can work to an end of efficiently discovering valuable, non-obvious information from a large collection of data. The data, in turn, may arise in fields ranging from e.g., marketing, finance, manufacturing, or retail.

### SUMMARY OF THE INVENTION

We have now discovered novel methodology for exploiting the advantages inherent generally in data mining technologies, in the particular field of department store space management applications.

Our work proceeds in the following way.

We have recognized that a typical and important paradigm for presently effecting department store space management, is a largely subjective, human paradigm, and therefore exposed to all the vagaries and deficiencies otherwise attendant on human procedures. In particular, the paradigm we have in mind works in the following way. First, a department store space manager develops a department store space database comprising a compendium of individual department store space-requirements—e.g., specific department store space-requirements which took place in its past. Secondly, and independently, the department store space manager develops in his mind a space availability database comprising the department store space manager's personal, partial, and subjective knowledge of (otherwise objective) retail facts culled from e.g., the marketing literature, the business literature, or input from colleagues or salespersons. Thirdly, the department store space manager subjectively correlates in his mind the necessarily incomplete and partial space-availability database, with the department store space-requirements' database, in order to promulgate an individual's department store space-requirements' prescribed department store space management and ultimate solution.

This paradigm is part science and part art, and captures one aspect of the problems associated with department store space management. However, as suggested above, it is manifestly a subjective paradigm, and therefore open to human vagaries.

We now disclose a novel computer method which can preserve the advantages inherent in this paradigm, while minimizing the incompleteness and attendant subjectivities that otherwise inure in a technique heretofore entirely reserved for human realization.

To this end, in a first aspect of the present invention, we disclose a novel computer method comprising the steps of:

i) providing a department store space-requirements database comprising a compendium of department store space-requirements history;

ii) providing a department store space-availability database comprising a compendium of at least one of department store space management solutions, department store space information, and department store space diagnostics; and

iii) employing a data mining technique for interrogating said department store space-requirements and department store space-availability databases for generating an output data stream, said output data stream correlating requirements problem with availability solution.

The novel method preferably comprises a further step of updating the step i) department store space-requirements database, so that it can cumulatively track the department store space-requirements history as it develops over time. For example, this step i) of updating the department store space-requirements database may include the results of employing the step iii) data mining technique. Also, the method may comprise a step of refining an employed data mining technique in cognizance of pattern changes embedded in each database as a consequence of department store space-solutions results and updating the department store space-requirements' database.

The novel method preferably comprises a further step of updating the step ii) department store space-availability database, so that it can cumulatively track an ever increasing and developing technical department store space management literature. For example, this step ii) of updating the department store space-availability database may include the effects of employing a data mining technique on the department store space-requirements' database. Also, the method may comprise a step of refining an employed data mining technique in cognizance of pattern changes embedded in each database as a consequence of department store space-solutions results and updating the department store space-solutions database.

The novel method may employ advantageously a wide array of step iii) data mining techniques for interrogating the department store space-requirements and department store space-solutions database for generating an output data stream, which output data stream correlates department store space-requirements' problem with department store space availability solution. For example, the data mining technique may comprise inter alia employment of the following functions for producing output data: classification-neural, classification-tree, clustering-geographic, clustering-neural, factor analysis, or principal component analysis, or expert systems.

In a second aspect of the present invention, we disclose a program storage device readable by machine to perform method steps for providing an interactive department store space management database, the method comprising the steps of:

i) providing a department store space-requirements database comprising a compendium of department store space-requirements history;

ii) providing a department store space-availability database comprising a compendium of at least one of department store space management solutions, department store space information, and department store space diagnostics; and

iii) employing a data mining technique for interrogating said department store space-requirements and department store space-availability databases for generating an output data stream, said output data stream correlating requirements problem with availability solution.

In a third aspect of the present invention, we disclose a computer comprising:

i) means for inputting a department store space-requirements database comprising a compendium of individual department store space-requirements history;

ii) means for inputting a department store space-availability database comprising a compendium of at least one of department store space management solutions, department store space information, and department store space diagnostics;

iii) means for employing a data mining technique for interrogating said department store space-availability databases; and

iv) means for generating an output data stream, said output data stream correlating department store space-requirements problem with department store space-availability solution.

We have now summarized the invention in several of its aspects or manifestations. It may be observed, that with respect to the prior art discussed above comprising the subjective paradigm approach to the problem of department store space management, that the summarized invention utilizes inter alia, the technique of data mining. We now point out, firstly, that the technique of data mining is of such complexity and utility, that as a technique, in and of itself, it cannot be used in any way as an available candidate solution for department store space management, to the extent that the problem of department store space management is only approached within the realm of the human-subjective solution to department store space management. Moreover, to the extent that the present invention uses computer techniques including e.g., data mining techniques, to an end of solving a problem of department store space management, it is not in general obvious within the context of the nominal problem and the technique of data mining, how they are to be in fact brought into relationship to provide a pragmatic solution to the problem of department store space management. It is rather an aspect of the novelty and unobviousness of the present invention that it discloses, on the one hand, the possibility for using the technique of data mining within the context of department store space management, and, moreover, on the other hand, discloses illustrative techniques that are required to in fact pragmatically bring the technique of data mining to actually solve the problem of department store space management.

### BRIEF DESCRIPTION OF THE DRAWING

The invention is illustrated in the accompanying drawing, in which

FIG. 1 provides an illustrative flowchart comprehending overall realization of the method of the present invention;

FIG. 2 provides an illustrative flowchart of details comprehended in the FIG. 1 flowchart;

FIG. 3 shows a neural network that may be used in realization of the FIGS. 1 and 2 data mining algorithm; and

FIG. 4 shows further illustrative refinements of the FIG. 3 neural network.

### DETAILED DESCRIPTION OF THE PRESENT INVENTION

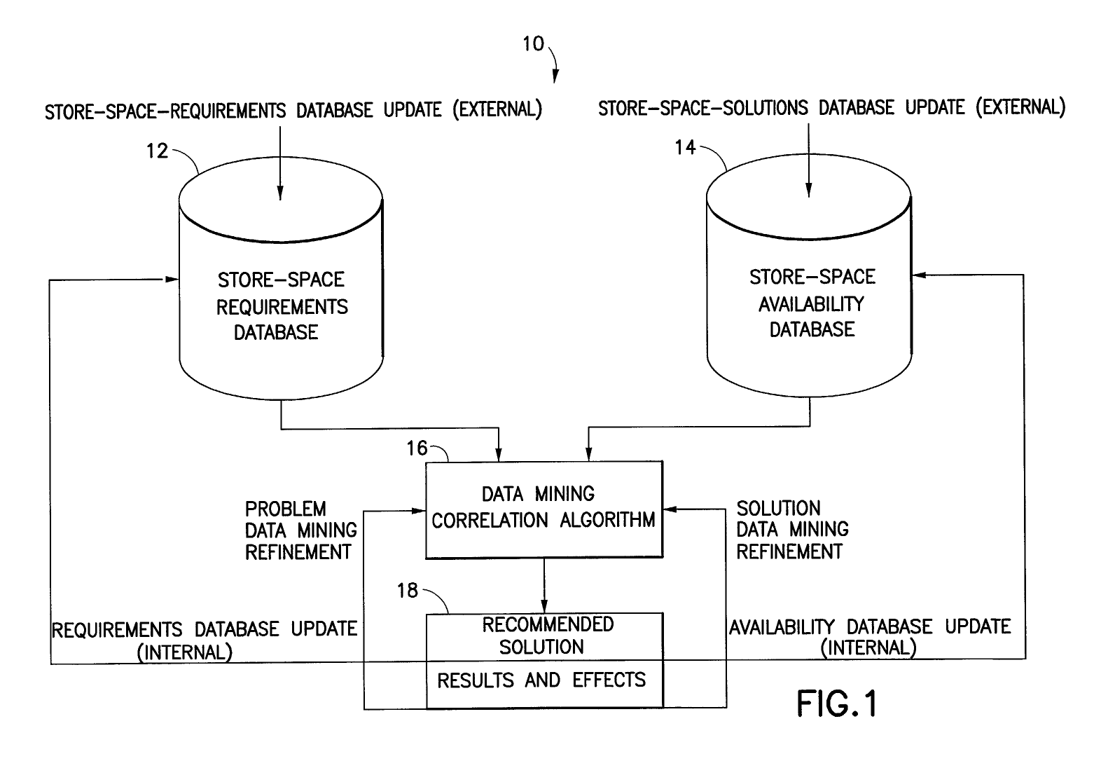

The detailed description of the present invention proceeds by tracing through the quintessential method steps, summarized above, that fairly capture the invention in all its sundry aspects. To this end, attention is directed to the flowcharts and neural networks of FIGS. 1 through 4, which can provide enablement of the three method steps.

FIG. 1, numerals 10-18, illustratively captures the overall spirit of the present invention. In particular, the FIG. 1 flowchart (10) shows a department store space-requirements database (12) comprising a compendium of individual department store space-requirements history, and a department store space-availability database (14) comprising a compendium of at least one of department store space management solutions, department store space information, and department store space diagnostics. Those skilled in the art will have no difficulty, having regard to their own knowledge and this disclosure, in creating or updating the databases (12,14) e.g., conventional techniques can be used to this end. FIG. 1 also shows the outputs of the department store space-requirements database (12) and department store space-availability database (14) input to a data mining correlation algorithm box (16). The data mining algorithm can interrogate the information captured and/or updated in the department store space-requirements and department store space-availability databases (12,14), and can generate an output data stream (18) correlating department store space-requirements problem with department store space-availability solution. Note that the output (18) of the data mining algorithm can be most advantageously, self-reflexively, fed as a subsequent input to at least one of the department store space-requirements database (12), the department store space-availability database (14), and the data mining correlation algorithm (16).

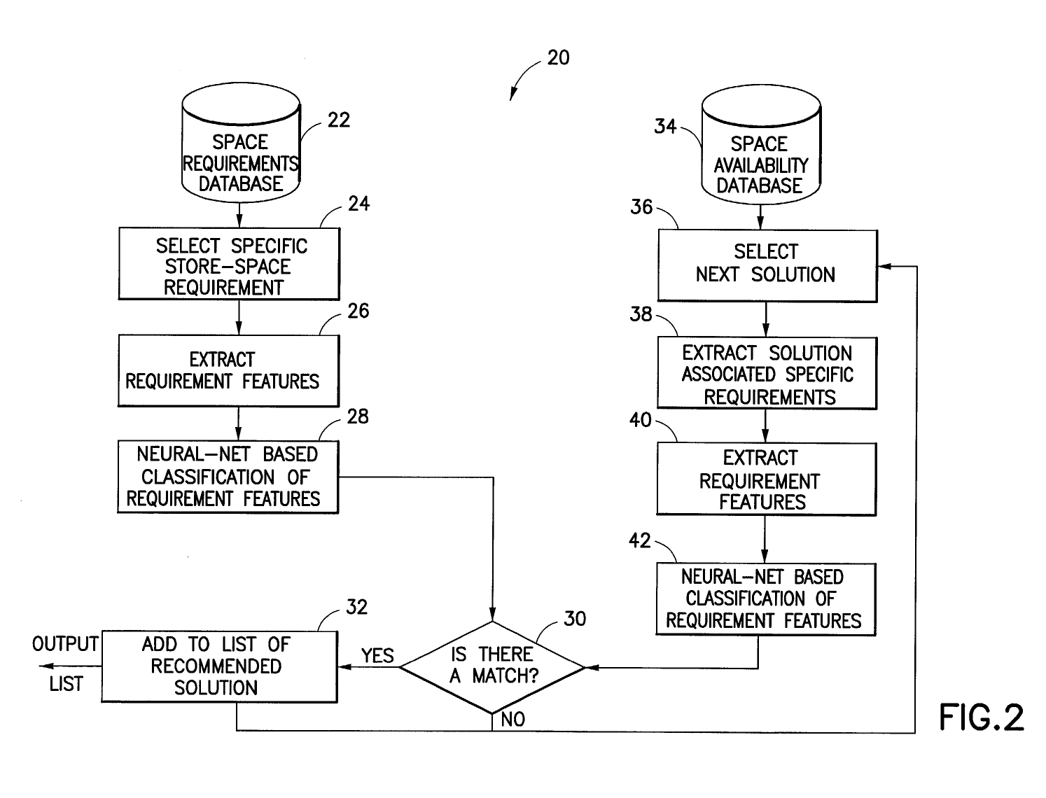

Attention is now directed to FIG. 2, which provides a flowchart (20-42) that recapitulates some of the FIG. 1 flowchart information, but adds particulars on the immediate correlation functionalities required of a data mining correlation algorithm. For illustrative purposes, FIG. 2 comprehends the data mining correlation algorithm as a neural-net based classification of department store space-requirements features, e.g., wherein a department store space-requirements feature for say, canned beans, may include can style, size, color, current local inventory, expected department store space-requirements by week, etc.

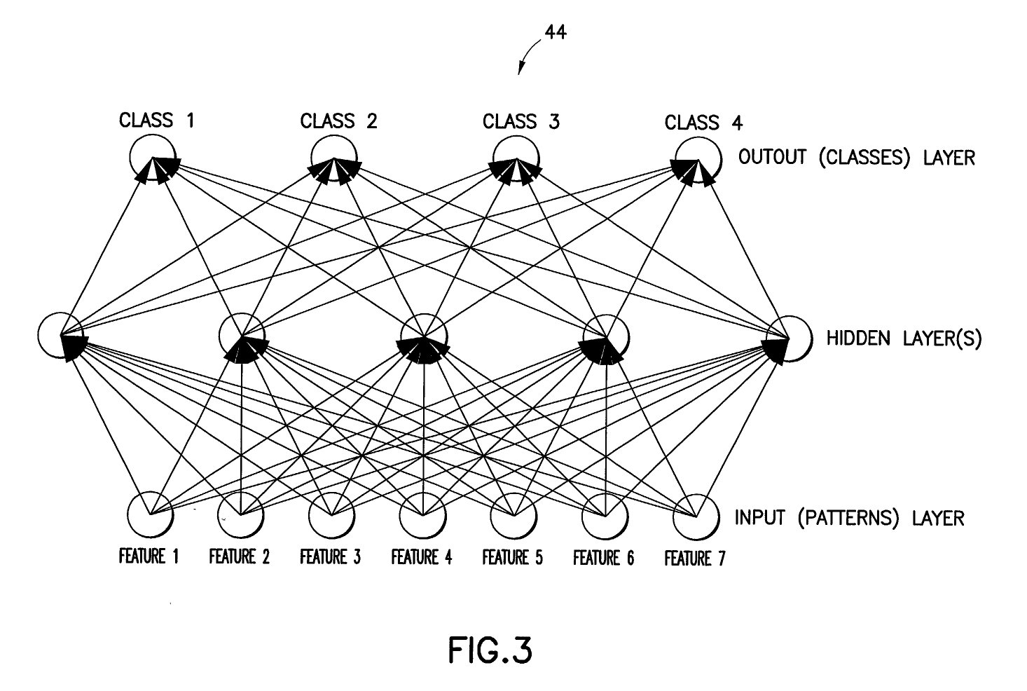

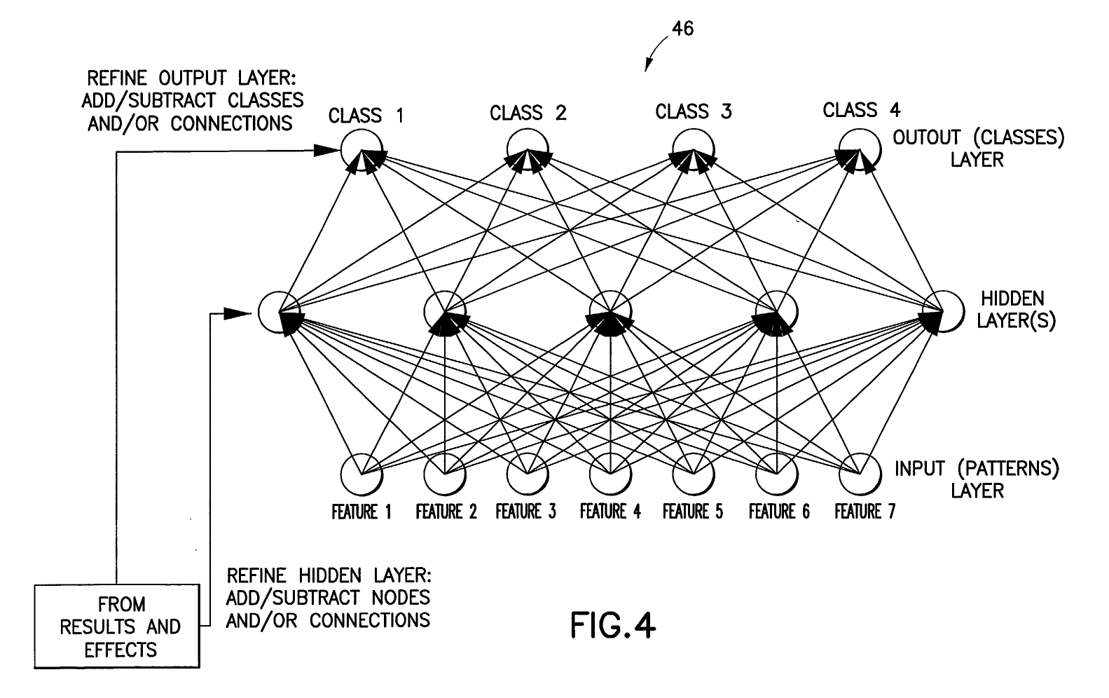

FIG. 3, in turn, shows a neural-net (44) that may be used in realization of the FIGS. 1 and 2 data mining correlation algorithm. Note the reference to classes which represent classification of input features. The FIG. 3 neural-net (44) in turn, may be advantageously refined, as shown in the FIG. 4 neural-net (46), to capture the self-reflexive capabilities of the present invention, as elaborated above.

It is well understood that the computer system and method of the present invention can be implemented using a plurality of separate dedicated or programmable integrated or other electronic circuits or devices (e.g., hardwired or logic circuits such as discrete element circuits, or programmable logic devices such as PLDs, PLAs, PALs, or the like). A suitably programmed general purpose computer, e.g., a microprocessor, microcontroller or other processor devices (CPU or MPU), either alone or in conjunction with one or more peripheral (e.g., integrated circuit) data and signal processing devices can be used to implement the invention. In general, any device or assembly of devices on which a finite state machine capable of implementing the flow charts shown in the figures can be used as a controller with the invention.

What is claimed:

1. A computer method comprising the steps of:
i) providing a department store space-requirements database comprising a compendium of individual department store space-requirements history;
ii) providing a department store space-availability database comprising a compendium of at least one of department store space management solutions, department store space information, and department store space diagnostics; and
iii) employing a data mining technique for interrogating said department store space-requirements and department store space-availability databases for generating an output data stream, said output data stream correlating department store space-requirements problem with department store space-availability solution.

2. A method according to claim 1, comprising a step of updating the department store space-requirements database.

3. A method according to claim 2, comprising a step of updating the department store space-requirements database so that it includes the results of employing a data mining technique.

4. A method according to claim 1, comprising a step of updating the department store space-availability database.

5. A method according to claim 4, comprising a step of updating the department store space-availability database so that it includes the effects of employing a data mining technique on the department store space-requirements database.

6. A method according to claim 2, comprising a step of refining a employed data mining technique in cognizance of pattern changes embedded in each database as a consequence of updating the department store space-requirements database.

7. A method according to claim 4, comprising a step of refining a employed data mining technique in cognizance of pattern changes embedded in each database as a consequence of updating the department store space-availability database.

8. A method according to claim 1, comprising a step of employing neural networks as the data mining technique.

9. A program storage device readable by machine, tangibly embodying a program of instructions executable by the machine to perform method steps for providing an interactive department store space management database, the method comprising the steps of:
i) providing a department store space-requirements database comprising a compendium of individual department store space-requirements history;
ii) providing a department store space-availability database comprising a compendium of at least one of department store space management solutions, department store space information, and department store space diagnostics; and
iii) employing a data mining technique for interrogating said department store space-requirements and department store space-availability databases for generating an output data stream, said output data stream correlating department store space-requirements problem with department store space-availability solution.

10. A computer comprising:
i) means for inputting a department store space-requirements database comprising a compendium of individual department store space-requirements history;
ii) means for inputting a department store space-availability database comprising a compendium of at least one of department store space management solutions, department store space information, and department store space diagnostics;
iii) means for employing a data mining technique for interrogating said department store space-requirements and department store space-availability databases; and
iv) means for generating an output data stream, said output data stream correlating department store space-requirements problem with department store space-availability solution.
